(19) United States
(12) Patent Application Publication
(10) Pub. No.: US 2005/0094811 A1
(43) Pub. Date: May 5, 2005

(54) Invisible encoded indicia comprised of latent image

(76) Inventor: Brian Mentz, Hamden, CT (US)

Correspondence Address: FULBRIGHT & JAWORSKI, LLP, 666 FIFTH AVE, NEW YORK, NY, 10103-3198, US

(21) Appl. No.: 10/964,023

(22) Filed: Oct. 12, 2004

Related U.S. Application Data
(60) Provisional application No. 60/510,514, filed on Oct. 10, 2003.

(51) Int. Cl. H04L 9/00

(52) U.S. Cl. 380/201

(57) ABSTRACT

A security device and method for visually scrambling a graphic element to provide a scrambled image and imparting the scrambled image to a substrate to form an invisible latent image that can be visualized by rendering the invisible latent image temporarily visible and descrambling the temporarily visible latent image. The device further comprises a decoding device for visualizing the graphic element by rendering the latent image temporarily visible and descrambling the temporarily visible latent image.

### RELATED APPLICATION

This application claims priority benefit under Title 35 U.S.C. §119(e) of provisional patent application no. 60/510,514, filed Oct. 10, 2003, which is incorporated by reference in its entirety.

### BACKGROUND OF THE INVENTION

The instant invention relates to improvements of “scrambled indicia” covert information embedding techniques that are well known in the anti-counterfeiting industry. Traditional applications of this and similar techniques are limited. Historically, scrambled indicia have been applied to a document of value or other substrate with opaque ink. The scrambled image is effectively decoded by placing the appropriate lens structure directly over the image and aligning the lens and image rotationally. Only with this decoding lens can the image be seen in its original, unscrambled state. Although the specific features of the original image are not legible without the decoding lens due to the intentional optical “scrambling”, there remains a printed visual artifact that is distracting and reduces the effectiveness of the overt design of the document. Additionally, the presence of this visual artifact can alert would-be counterfeiters that a scrambled indicia technique has been applied to certain information on or within the document. The awareness of the presence of a security-enhancing element is the first necessary step in de-scrambling and ultimately, defeating the traditional technology.

### SUMMARY OF THE INVENTION

The present invention avoids these and other limitations through the application of scrambled indicia techniques that are printed or otherwise applied to a substrate with effectively invisible inks or other marking techniques that can impart a latent image pattern. The latent image is then subjected to a secondary condition that renders it visible, and a decoding lens can be used to descramble the image that has temporarily been rendered visible.

One of various traditional types-of scrambling schema is used to create an optically modified rendering of some image or pattern that is to remain covert. The pattern is applied to the intended substrate before, during, or after the overt image printing occurs. The covert, scrambled image is imparted to the document with an ink or other substance that is essentially colorless in that part of the electromagnetic spectrum to which the human eye is sensitive (i.e., approximately of 400-700 nanometer wavelength). Ideally, the ink or other substance will have a gloss, or lack thereof, which matches the base substrate to avoid identification by inspection at oblique angles. The colorless substance can be comprised of ultra-violet (UV) fluorescing agents or infrared (IR) fluorescing agents. The application of the correct excitation wavelength(s) will cause the scrambled image to appear at wavelengths visible to the human eye. At this time a descrambling lens can be simultaneously placed on top of the scrambled image to extract the original, unscrambled image. Alternately, the latent scrambled image can be imparted to the substrate through other means, such as photographic exposure, liquid crystal compounds, mechanical embossing, and other technologies capable of imparting latent images to the substrates.

To prevent unauthorized duplication or alteration of documents, frequently there is special indicia or a background pattern provided for sheet materials such as tickets, checks, currency and the like. The indicia or background pattern is imposed upon the sheet material usually by some type of printing process, such as offset printing, lithography, letterpress or other like mechanical systems, by a variety of photographic methods, by xeroprinting, and a host of other methods. The pattern or indicia may be produced with ordinary inks, from special inks which may be magnetic, fluorescent, or the like, from powders which may be baked on, from light sensitive materials such silver salts and azo dyes, and the like. Most of these patterns placed on sheet materials depend upon complexity and resolution to avoid ready duplication. Consequently, they add an increment of cost to the sheet material without being fully effective in many instances in providing the desired protection from unauthorized duplication or alteration. Such products and encoding systems are disclosed in U.S. Pat. Nos. 3,937,565; 4,092,654; 4,198,147; 4,914,700; and 5,708,717, which are incorporated herein by reference in their entirety.

An object of the present invention is, therefore, to provide an improved and novel system for coding and decoding indicia or printed matter. Yet other objects of the present invention are to provide a novel sheet material having indicia thereon in scrambled or coded form; to provide a system for decoding such novel sheet material; and to provide a novel method for producing visually scrambled or coded indicia.

To effect the foregoing and other objects of the present invention, generally there is provided sheet material upon which indicia are imprinted in scrambled form that readily lends itself to decoding, yet which is extremely difficult to reproduce without intimate knowledge of parameters involved in producing it. The indicia are preferably produced photographically in the manner, which scrambles the indicia so that it cannot be directly identified without unscrambling or decoding. The photographic method employs an autostereoscopic camera, such as the one described in U.S. Pat. No. 3,524,395 or U.S. Pat. No. 3,769,890. The disclosures of U.S. Pat. Nos. 3,524,395 and 3,769,890 are incorporated herein by reference in their entirety.

In accordance with an embodiment of the present invention, a method of generating a scrambled image comprises the steps of visually scrambling a graphic element to provide a scrambled image and imparting the scrambled image to a substrate to form an invisible latent image that can be visualized by rendering the invisible latent image temporarily visible and descrambling the temporarily visible latent image.

In accordance with an embodiment of the present invention, a security device comprises a scrambling device for visually scrambling a graphic element to provide a scrambled image and imparting the scrambled image to a substrate to form an invisible latent image that can be visualized by rendering the invisible latent image temporarily visible and descrambling the temporarily visible latent image.

In accordance with an embodiment of the present invention, the security device as aforesaid, additionally comprises a decoding device for visualizing the graphic element by rendering the latent image temporarily visible and descrambling the temporarily visible latent image.

In accordance with an embodiment of the present invention, a product, such as a novelty toy, scratch-off game and the like, comprises a scrambling device for visually scrambling a graphic element to provide a scrambled image and imparting the scrambled image to a substrate to form an unintelligible latent image that can be visualized by rendering the unintelligible image temporarily intelligible and descrambling the temporarily visible latent image.

Various other objects, advantages and features of the present invention will become readily apparent from the ensuing detailed description, and the novel features will be particularly pointed out in the appended claims.

### BRIEF DESCRIPTION OF THE DRAWINGS

The following detailed description, given by way of example, and not intended to limit the present invention solely thereto, will best be understood in conjunction with the accompanying drawings in which:

FIG. 1 is a diagram of a graphic element or design comprising the letters “ABNH”;

FIG. 2 is an exemplary diagram of the graphic element of FIG. 1 scrambled in accordance with an embodiment of the present invention;

FIG. 3 is an exemplary diagram of the scrambled image of FIG. 2 that has been made unintelligible or invisible in accordance with an embodiment of the present invention;

FIG. 4 is an exemplary diagram of the invisible latent image of FIG. 3 that has been made temporarily visible in accordance with an embodiment of the present invention; and

FIG. 5 is an exemplary diagram of the temporarily visible latent image of FIG. 4 that has been descrambled in accordance with an embodiment of the present invention.

### DETAILED DESCRIPTIONS OF THE EMBODIMENTS

In accordance with an embodiment of the present invention, autostereoscopic photographs in the form of parallax panoramagrams are produced utilizing a camera having a conventional objective lens, preferably corrected to have a flat field (generally defined as that surface in which the sharpest images are formed by a lens system when the viewed object is at infinity, or the loci of all points of collimated light imaged by the lens system). During the period of exposure, the lens is moved relative to the subject in a generally horizontal direction, linearly and at a right angle to the optical axis of the lens. This movement causes a continuously changing aspect of the subject to be presented to the camera lens. A graticule, in the form of a grid comprising narrow, substantially vertical and parallel opaque strips separated by narrower transparent strips or, preferably a lenticular screen comprising substantially vertical contiguous cylindrical lenticules, is located between the lens and the image plane (defined as that surface, generally referred to as a plane at which a lens system forms the sharpest image of an object which is at some position in front of the lens) closely adjacent the image plane. A photosensitive element such as a sensitized film is positioned at the combined image plane of the lens and graticule. During exposure, the graticule and film are moved together relative to the lens to expose successive portions of the photosensitive element underlying the graticule. One method employed in autostereography is to move during exposure the camera lens from an initial position through an intermediate position to a terminal position, and at the same time to move the camera back simultaneously and along a parallel path at a faster rate than the lens, such that a light ray from a point near the center of the subject or scene being photographed, (hereinafter called the “subject center”) passing through the nodal point of the lens, is always incident upon a graticule at the same point. However, due to the spacing between the lens surfaces of the graticule and photosensitive element, the ray will fall upon the photosensitive element at progressively different points as the camera lens and back are moved, so that different aspects of the subject are presented to the lens and recorded by the photosensitive element.

Thus, if the effective lens aperture of the camera is “wide open” so that the depth of field of the camera is restricted, the camera will invariably also be focussed with the subject center at the first conjugate point and the image of the subject center at the second conjugate point (the point where the image plane and the principal optical axis intersect) in order to obtain a reasonably sharp picture. In the method of the present invention, the camera however, is deliberately defocused from the subject center (either in front or in back thereof) while the camera elements are still set up so that the light rays from the subject center pass through the second conjugate point of the lens. The effective lens aperture of the camera is then “stopped down” sufficiently to increase the depth of focus such that the defocused image now appears to be reasonably sharp and clear. Alternatively, the effective lens aperture of the camera can first be “stopped down” to locate the image plane and then defocused. This produces a photograph which is not only a lenticular dissection of the image, but in which the displacement between the subject center and the second conjugate point introduces a scrambling factor. This photograph can be recorded on film, preferably of the self-developing type, or if multiple versions of the scrambled indicia are desired, screen positives (typically using a fine screen of substantially 300 lines per inch if the indicia to be printed are half tones) can then be made from the photographic image provided by the camera. A printing plate is then prepared from the positive, and sheet material is printed from the plate, for example, by an offset printing machine. It should be understood that the printing plate may also be made from the negative and that other printing systems can be employed to produce printed multiple versions of the indicia on sheet material. The defocused lenticular dissections or scrambled indicia thus printed are essentially unrecognizable in the sense that the original form of the indicia cannot be identified by unaided vision. The scrambled indicia, however, can be reconstructed, unscrambled or decoded by positioning over the printed image, a transparent lenticular screen of the same nature as that used in the camera in terms of the number of lenticules per inch and the radius of curvature of the lenticules, provided, however, that the lenticular screen is positioned in the same relation to the scrambled indicia as it was positioned to the photographic image from which the printing plates were made, and also provided that there has been no magnification, either positive or negative, of the printed form of the scrambled indicia with respect to the photographic image.

It is appreciated that the present system can be used for many purposes such as background patterns, on documents which must be safeguarded against erasures, forgeries, counterfeiting and the like. The system may also be used for games and educational purposes, where, for example, test answers in the scrambled or coded form according to the invention can be put on the same test sheet as that containing the questions in uncoded form. Due to the inherent properties of the system, it can be used for all kinds of work other than line work, logos, solids and signatures, such as for continuous tone and half-tone material.

The present invention can be used in applications other than ink-on-paper documents, such as laminated or otherwise constructed ID cards, holographic laminates, holographic labels, credit cards, non-holographic laminates, holographic and non-holographic hot-stamp foils, novelty toys, scratch-off cards, lottery, among others. The present invention is not limited in practice to any specific base substrate.

Exemplary applications of the present invention are now described:

### EXAMPLE #1

A design comprising the stylized letters “RIO” is generated. A scrambling algorithm is applied to the design, rendering it scrambled and unintelligible to the naked eye. The scrambling algorithm is consistent with the characteristics of the particular decoding device that will be used to descramble the image.

The scrambled design is then replicated on a continuous or discrete substrate using known printing techniques. The scrambled design is effectively invisible but latent.

The continuous or discrete substrate is then used to produce some item(s) in the usual manner.

The finished item shows no evidence of the presence of a scrambled design. However, upon application of an enabling factor, the scrambled image becomes visible and can be descrambled with the decoding device.

### EXAMPLE #2

A line-art design comprising the word “authentic” is generated on a computer. A computer optical scrambling algorithm is applied to the design, rendering it scrambled and unintelligible to the naked eye. The scrambling algorithm is based upon the known transmission characteristics of the particular decoding device—in this example a cylindrical lenticular lens with a pitch of 0.1 [mm]—that will be placed directly on the scrambled image in order to descramble it. This algorithm can be either a computerized graphic function or can be an optical process that alters the image as desired.

The scrambled design is then replicated using known techniques into a flexographic printing plate. The flexographic printing plate is mounted on a flexographic printing press print cylinder and mounted in the print station of the press. Ultra violet (UV) fluorescing ink that appears clear and colorless at those wavelengths of light detectable by the human eye is added to the ink pan for this particular print station. The ink is solvent based and is cured by evaporating the solvent vehicle after application to the web.

A 15″ wide web of print-treated polyester material is webbed through the printing press in a manner consistent with regular printing operations. The press is started and the print cylinder is engaged to contact the polyester web such that the scrambled pattern is printed on the surface of the web in UV fluorescing ink. The web passes through at least one heater to evaporate the solvent base, leaving the ink essentially permanently attached to the polyester web.

The polyester web is then used to produce holographic label stock in the usual manner.

The finished hologram shows no evidence of the presence of a scrambled design. However, upon excitation with the appropriate wavelength(s) of UV light, the scrambled design becomes visible. When the appropriate descrambling lens is placed upon the holographic web and aligned rotationally, the image is descrambled and the word “authentic” is revealed through the lens.

### EXAMPLE #3

A graphic design comprising the word “valid” is created with mixed media. An optical scrambling technique is applied to the design, rendering it scrambled and unintelligible to the naked eye. The scrambling technique incorporates the use of a copy of the very decoding device that will be used to de-scramble the image. The scrambled image is recorded on a photographic emulsion and developed using known techniques.

The scrambled design is then replicated using known techniques into a gravure cylinder. The gravure cylinder is mounted in the print station of a gravure printing press. Ultra violet (UV) fluorescing ink that appears clear and colorless at those wavelengths of light detectable by the human eye is added to the ink pan for this particular print station. Exposing it to UV radiation after application to the web cures the ink.

A 20″ wide web of print-treated polystyrene material is webbed through the printing press in a manner consistent with regular printing operations. The press is started and the print cylinder is engaged to contact a transfer roller, the transfer roller then contacting the polystyrene web such that the scrambled pattern is printed on the surface of the web in UV fluorescing ink. The web passes through at least one UV curing station, leaving the ink essentially permanently attached to the polystyrene web.

The polystyrene web is then used to produce holographic label stock in the usual manner.

The finished hologram shows no evidence of the presence of a scrambled design. However, upon excitation with the appropriate wavelength(s) of UV light, the scrambled design becomes visible. When the appropriate descrambling lens is placed upon the holographic web and aligned rotationally, the image is descrambled and the word “valid” is revealed through the lens.

### EXAMPLE #4

A graphic design comprising the image of a corporate logo is generated on a computer. A scrambling algorithm is applied to the design, rendering it scrambled and unintelligible to the naked eye. The scrambling algorithm is based upon the known transmission characteristics of the particular decoding device—in this example a complex lenticular lens—which will be placed directly on the scrambled image in order to de-scramble it.

The scrambled design is then replicated using known techniques into an optical transparency. This transparency is then used, in conjunction with a source of polarized electromagnetic radiation, to create regions of known molecular orientation in a layer of polymer that has been applied to a substrate. The substrate is then subsequently coated with a compound comprising liquid crystals. The liquid crystals align with the orientation characteristics of the polymer coating and are cured in this aligned state so as to permanently fix the liquid crystals in this orientation. This substrate can be in the form of a continuous web of optically clear material.

The finished substrate then demonstrates the ability to render visible the scrambled image when viewed in conjunction with a polarizing filter(s). In order to view the descrambled image, the polarizing filter(s) is used in conjunction with the intended decoding lens.

### EXAMPLE #5

A line-art design comprising the words “genuine credit card” is generated on a computer. A computer optical scrambling algorithm is applied to the design, rendering it scrambled and unintelligible to the naked eye. The scrambling algorithm is based upon the known transmission characteristics of the particular decoding device—in this example a cylindrical lenticular lens with a pitch of 0.1 [mm]—that will be placed directly on the scrambled image in order to descramble it.

The scrambled design is then replicated using known techniques into a flexographic printing plate. The flexographic printing plate is mounted on a flexographic printing press print cylinder and mounted in the print station of the press. Ultra violet (UV) fluorescing ink that appears clear and colorless at those wavelengths of light detectable by the human eye is added to the ink pan for this particular print station. The ink is UV curable and is cured by exposing to UV radiation after application to the web.

A web of 92 gauge polyester material is webbed through the printing press in a manner consistent with regular printing operations. The polyester material has been previously coated with a release coat on the side to be printed. The press is started and the print cylinder is engaged to contact the polyester web such that the scrambled pattern is printed on the release coat surface of the web in UV fluorescing ink. The web passes through at least one UV curing station, leaving the ink attached to the release coat that has been applied to the polyester web.

The polyester web is then subjected to the usual further operations of embossable resin coat and vacuum deposited aluminization prior to having holographic images embossed into its surface. This process is typical of the process used to create holographic hot stamp foil for application to credit cards.

Alternatively, the scrambled image is printed between the embossable resin and aluminum coatings, or elsewhere in the multi-layered construction of the hot stamp foil.

The holographic hot stamp material is then applied to the credit card substrate in essentially the usual manner. The finished hologram shows no evidence of the presence of a scrambled design. However, upon excitation with the appropriate wavelength(s) of UV light, the scrambled design becomes visible. When the appropriate descrambling lens is placed upon the holographic web and aligned rotationally, the image is descrambled and the words “genuine credit cards” are revealed through the lens on the holographic stamp.

Similarly, the application of liquid crystals, as described above, to the hot stamp material is a viable alternative. In this case, the latent, scrambled image is rendered visible with the appropriate polarizing filter(s), and decoded with the appropriate lens.

### EXAMPLE #6

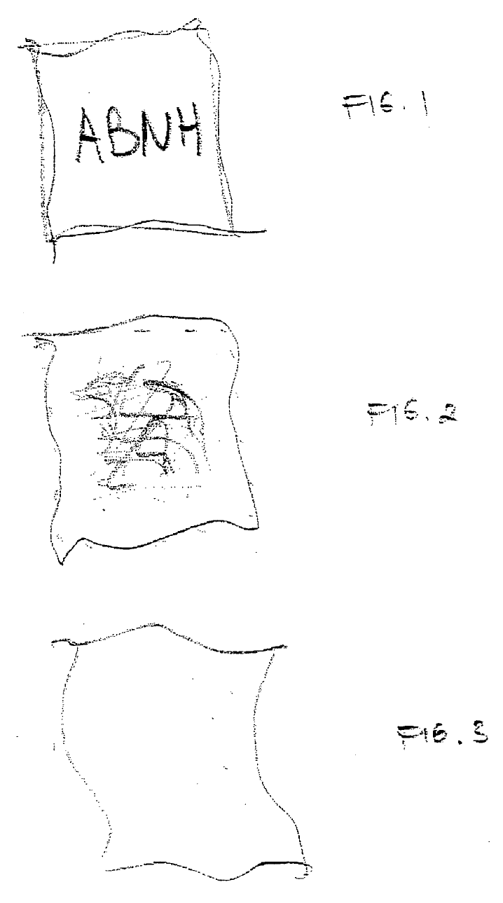

As shown in FIG. 1, a design comprising the letters “ABNH” is generated. A scrambling algorithm is applied to the design, rendering it scrambled and unintelligible to the naked eye depicted as in FIG. 2. The scrambling algorithm is consistent with the characteristics of the particular decoding device that will be used to descramble the image.

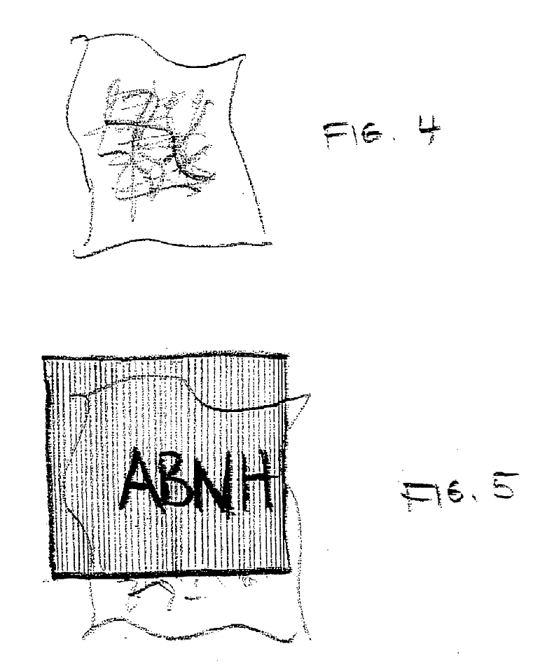

The scrambled design is then replicated in thermochromic ink on a continuous or discrete substrate using known printing techniques. As shown in FIG. 3, the scrambled design is effectively invisible but latent at room temperatures.

The continuous or discrete substrate is then used to produce some item(s) in the usual manner.

The finished item shows no evidence of the presence of a scrambled design. However, upon application of sufficient heat, the thermochromic ink transitions from a transparent to a visible color or level of opacity sufficient to allow visualization of the scrambled image as shown in FIG. 4. The scrambled image can then be descrambled with the decoding device, revealing the letters “ABNH” as depicted in FIG. 5.

### EXAMPLE #7

A design comprising a barcode is generated. A scrambling algorithm is applied to the design, rendering it scrambled and unintelligible to the naked eye. The scrambling algorithm is consistent with the characteristics of the particular decoding device that will be used to descramble the image.

The scrambled design is then replicated using “Chemical A” on a continuous substrate using known printing techniques. “Chemical A” comprises one of a two-part system which, when combined, temporarily cause the applied and cured “Chemical A” to increase in opacity to a level sufficient for viewing. The scrambled design is effectively invisible but latent.

The continuous substrate is then used to produce some item(s) in the usual manner.

The finished item shows no evidence of the presence of a scrambled design. However, upon application of “Chemical B”, the latent image comprised of “Chemical A” becomes temporarily visible, and can be descrambled with the decoding device. “Chemical B” is formulated such that it will evaporate or otherwise disperse, after which “Chemical A” becomes latent once again.

In accordance with an embodiment of the present invention, the method comprises the following steps:
1) generating a graphic element;
2) visually scrambling the graphic element;
3) imparting the scrambled image to a substrate such that it is an invisible, latent image,
4) visualizing the decoded image by applying, in conjunction,
   A) a condition that renders the latent image temporarily visible, and
   B) a decoding device that un-scrambles the visible image to present the original graphic element.

Any technique that satisfactorily achieves these four (4) steps, in any possible combination, is meant to be included in this disclosure of the instant invention.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A method of generating a scrambled image comprising the steps of:
visually scrambling a graphic element to provide a scrambled image; and
imparting the scrambled image to a substrate to form an invisible latent image that can be visualized by rendering said invisible latent image temporarily visible and descrambling the temporarily visible latent image.

2. The method of claim 1, further comprising the step of visualizing the graphic element by rendering said invisible latent image temporarily visible and descrambling the temporarily visible latent image.

3. The method of claim 1, further comprising the step of generating said graphic element.

4. The method of claim 1, further comprising the step of incorporating said scrambled image in an product.

5. The method of claim 1, wherein the step of imparting comprises the step of applying liquid crystals to said substrate to generate said invisible latent image, the molecular alignment of said liquid crystals corresponding essentially to the pattern of said invisible latent image.

6. The method of claim 2, wherein the step of visualizing comprises the step of placing a polarizing filter proximate to said substrate to render said invisible latent image temporarily visible.

7. The method of claim 1, wherein the step of imparting comprises the step of printing said invisible latent image on a substrate with UV fluorescing ink, dye, or other suitable mixture incorporating said ink or dye.

8. The method of claim 1, wherein the step of imparting comprises the step of printing said invisible latent image on a substrate with IR fluorescing ink or dye, dye, or other suitable mixture incorporating said ink or dye.

9. The method of claim 2, wherein the step of visualizing comprising the step of illuminating said invisible latent image with electromagnetic radiation to render said invisible latent image temporarily visible.

10. A security device comprising a scrambling device for visually scrambling a graphic element to provide a scrambled image and imparting the scrambled image to a substrate to form an invisible latent image that can be visualized by rendering said invisible latent image temporarily visible and descrambling the temporarily visible latent image.

11. The security device of claim 10, further comprising a decoding device for visualizing the graphic element by rendering the latent image temporarily visible and descrambling the temporarily visible latent image.

12. The security device of claim 10, further comprising a device for generating said graphic element.

13. The security device of claim 11, wherein said decoding device comprises an image enabler for rendering the latent image temporarily visible and a descrambler for descrambling the temporarily visible latent image.

14. The security device of claim 10, wherein said scrambling device is operable to apply liquid crystals to said substrate to generate said invisible latent image, the molecular alignment of said liquid crystals corresponding essentially to the pattern of said invisible latent image.

15. The security device of claim 11, wherein said decoding device comprises a polarizing filter placed proximately to said substrate to render said invisible latent image temporarily visible.

16. The security device of claim 10, wherein said invisible latent image comprises an image printed on a substrate with UV fluorescing ink, dye, or other suitable mixture incorporating said ink or dye.

17. The security device of claim 10, wherein said invisible latent image comprises an image printed on a substrate with IR fluorescing ink or dye, dye, or other suitable mixture incorporating said ink or dye.

18. The security device of claim 11, wherein said decoding device is operable to illuminate said invisible latent image with electromagnetic radiation to render said invisible latent image temporarily visible.

19. The security device of claim 11, wherein said decoding device comprises a lens to descramble the temporarily visible latent image.

20. The security device of claim 11, wherein said decoding device comprises a lenticular lens to descramble the temporarily visible latent image.

21. A product which incorporates the security device of claim 10.

22. A product comprising a scrambling device for visually scrambling a graphic element to provide a scrambled image and imparting the scrambled image to a substrate to form an unintelligible latent image that can be visualized by rendering said unintelligible image temporarily intelligible and descrambling the temporarily visible latent image.

23. The product of claim 22, further comprising a decoding device for visualizing the graphic element by rendering the latent image temporarily intelligible and descrambling the temporarily intelligible latent image.
